(19) United States
(12) Patent Application Publication
(10) Pub. No.: US 2023/0107877 A1
(43) Pub. Date: Apr. 6, 2023

(54) GAS TURBINE ENGINE STATIONARY VANE WITH CONTOURED PLATFORM

(71) Applicant: Siemens Energy Global GmbH & Co. KG, München (DE)

(72) Inventors: John J. Marra, Oviedo, FL (US); John Pokorny, Orlando, FL (US)

(21) Appl. No.: 17/904,176

(22) PCT Filed: Feb. 26, 2020
(86) PCT No.: PCT/US2020/019878

§ 371 Date: Aug. 12, 2022

(51) Int. Cl. F01D 9/04

(52) U.S. Cl. CPC F01D 9/041; F05D 2240/80; F05D 2250/38; F05D 2250/14; F05D 2230/10

(57) ABSTRACT

A gas turbine engine includes a rotor rotatable about a central axis. The gas turbine engine includes a turbine stage including a stationary portion and a rotating portion made up of a number of rotating blades and a plurality of stationary vanes arranged to define the stationary portion. Each stationary vane includes an inner rail having an inlet face, a suction side face, a pressure side face, and a platform. A vane portion extends along a radial line from the platform and defines one of a first stagger angle and a second stagger angle with respect to the central axis. The platform has an elliptical cross-section in a plane that includes the central axis.

### BACKGROUND

Gas turbine engines are used in many applications including power generation. Gas turbine engines for power generation are generally designed for optimum performance at a particular load. Operation off this design point can result in additional unwanted emissions and less efficient operation.

### BRIEF SUMMARY

A gas turbine engine includes a rotor rotatable about a central axis. The gas turbine engine includes a turbine stage including a stationary portion and a rotating portion made up of a number of rotating blades and a plurality of stationary vanes arranged to define the stationary portion. Each stationary vane includes an inner rail having an inlet face, a suction side face, a pressure side face, and a platform. A vane portion extends along a radial line from the platform and defines one of a first stagger angle and a second stagger angle with respect to the central axis. The platform has an elliptical surface in a plane that includes the central axis.

In another construction, a gas turbine engine includes a first stationary vane including an inner rail having an inlet face, a suction side face, a pressure side face, and a platform. A vane portion extends along a radial line from the platform and defines one of a first stagger angle and a second stagger angle with respect to a central axis. A second stationary vane, identical to the first stationary blade includes a suction side face positioned in contact with the pressure side face of the first stationary vane to define a first throat area when the first stationary vane and the second stationary vane are oriented at the first stagger angle, and a second throat area when the first stationary vane and the second stationary vane are oriented at the second stagger angle. The inlet face of the first stationary vane cooperates with the inlet face of the second stationary vane to define a continuous annular surface and the platform of the first stationary vane cooperating with the platform of the second stationary vane to define a continuous curvilinear surface when the first stationary vane and the second stationary vane are oriented at the first stagger angle, and the platform of the first stationary vane cooperating with the platform of the second stationary vane to define a stepped surface when the first stationary vane and the second stationary vane are oriented at the second stagger angle.

In yet another construction, a method of setting the throat area of a row of stationary vanes for a gas turbine engine includes forming each stationary vane of the row of stationary vanes to include an inner rail having an inlet face, a suction side face, a pressure side face, a platform, a vane portion extending along a radial line from the platform and defining a first stagger angle and an outer rail including a bolt face. The method further includes adjusting a plane of the bolt face of each of the stationary vanes to define a second stagger angle and positioning the suction side face of each stationary vane in contact with the pressure side face of an adjacent stationary vane. The inlet face of each of the stationary vanes cooperate to define a continuous annular surface, the platform of each of the stationary vanes cooperate to define a continuous curvilinear surface, and the vane portion of each of the stationary vanes cooperate to define a first throat area when the stationary vanes are not adjusted, and the platform of each of the stationary vanes cooperate to define a stepped surface, and the vane portion of each of the stationary vanes cooperate to define a second throat area when the stationary vanes are adjusted.

### BRIEF DESCRIPTION OF THE DRAWINGS

To easily identify the discussion of any particular element or act, the most significant digit or digits in a reference number refer to the figure number in which that element is first introduced.

FIG. 1 is a cross-sectional longitudinal view of a gas turbine engine.

FIG. 2 illustrates a bladed stage of the gas turbine engine.

FIG. 3 illustrates a partial row of stationary vanes of the gas turbine engine.

FIG. 4 is a radial view of a partial row of stationary vanes of the gas turbine engine.

FIG. 5 illustrates two on-design vanes of the gas turbine engine.

FIG. 6 illustrates a pair of off-design vanes of the gas turbine engine.

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard as available a variation of 20 percent would fall within the meaning of these terms unless otherwise stated.

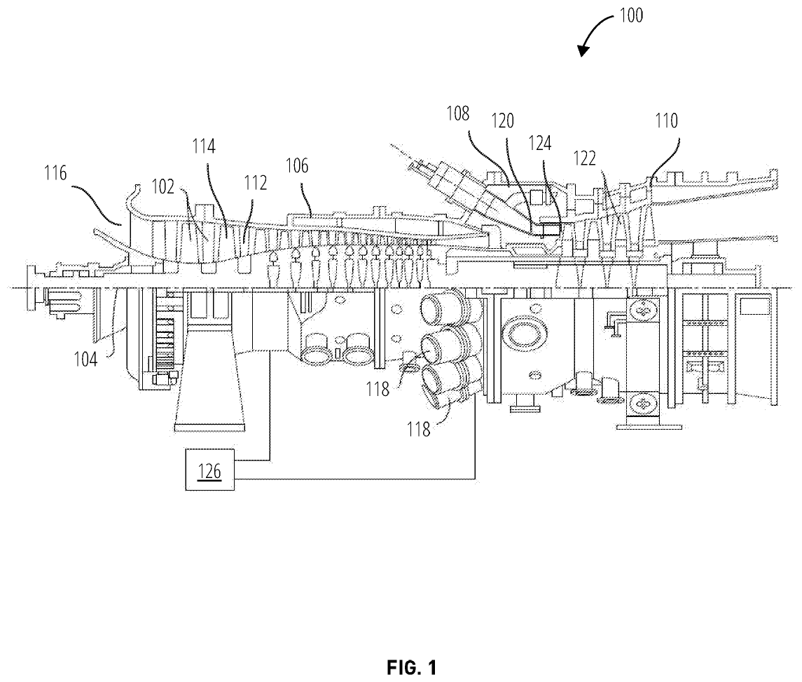

FIG. 1 illustrates an example of a gas turbine engine 100 including a compressor section 106, a combustion section 108, and a turbine section 110 arranged along a central axis 104. The compressor section 106 includes a plurality of compressor stages 102 with each stage including a set of rotating blades 112 and a set of stationary vanes 114 or adjustable guide vanes. The compressor section 106 is in fluid communication with an inlet section 116 to allow the gas turbine engine 100 to draw atmospheric air into the compressor section 106. During operation of the gas turbine engine 100, the compressor section 106 draws in atmospheric air and compresses that air for delivery to the combustion section 108.

In the illustrated construction, the combustion section 108 includes a plurality of separate combustors 118 that each operate to mix a flow of fuel with the compressed air from the compressor section 106 and to combust that air-fuel mixture to produce a flow of high temperature, high pressure combustion gases or exhaust gas 120. Of course, many other arrangements of the combustion section 108 are possible.

The turbine section 110 includes a plurality of turbine stages 122 with each stage including a number of rotating blades and a number of stationary blades or vanes. The turbine stages 122 are arranged to receive the exhaust gas 120 from the combustion section 108 at a turbine inlet 124 and expand that gas to convert thermal and pressure energy into rotating or mechanical work. The turbine section 110 is connected to the compressor section 106 to drive the compressor section 106. For gas turbine engines used for power generation or as prime movers, the turbine section 110 is also connected to a generator, pump, or other device to be driven.

A control system 126 is coupled to the gas turbine engine 100 and operates to monitor various operating parameters and to control various operations of the gas turbine engine 100. In preferred constructions the control system 126 is typically micro-processor based and includes memory devices and data storage devices for collecting, analyzing, and storing data. In addition, the control system 126 provides output data to various devices including monitors, printers, indicators, and the like that allow users to interface with the control system 126 to provide inputs or adjustments. In the example of a power generation system, a user may input a power output set point and the control system 126 adjusts the various control inputs to achieve that power output in an efficient manner.

The control system 126 can control various operating parameters including, but not limited to variable inlet guide vane positions, fuel flow rates and pressures, engine speed, valve positions, and generator load. Of course, other applications may have fewer or more controllable devices. The control system 126 also monitors various parameters to assure that the gas turbine engine 100 is operating properly. Some parameters that are monitored may include inlet air temperature, compressor outlet temperature and pressure, combustor outlet temperature, fuel flow rate, generator power output, and the like. Many of these measurements are displayed for the user and are logged for later review should such a review be necessary. It is also desirable to determine a turbine inlet temperature. However, as will be discussed in greater detail, this temperature is difficult to directly measure.

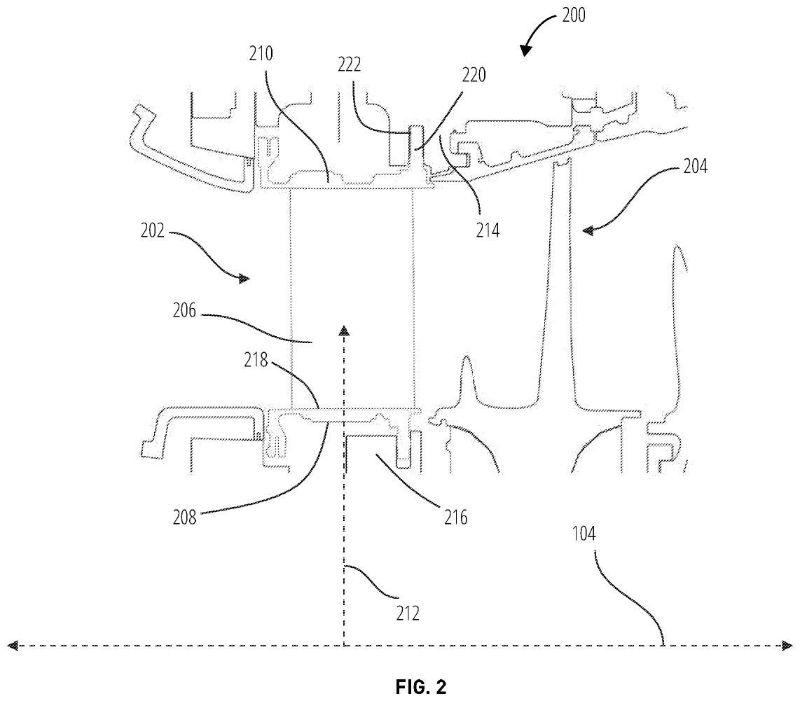

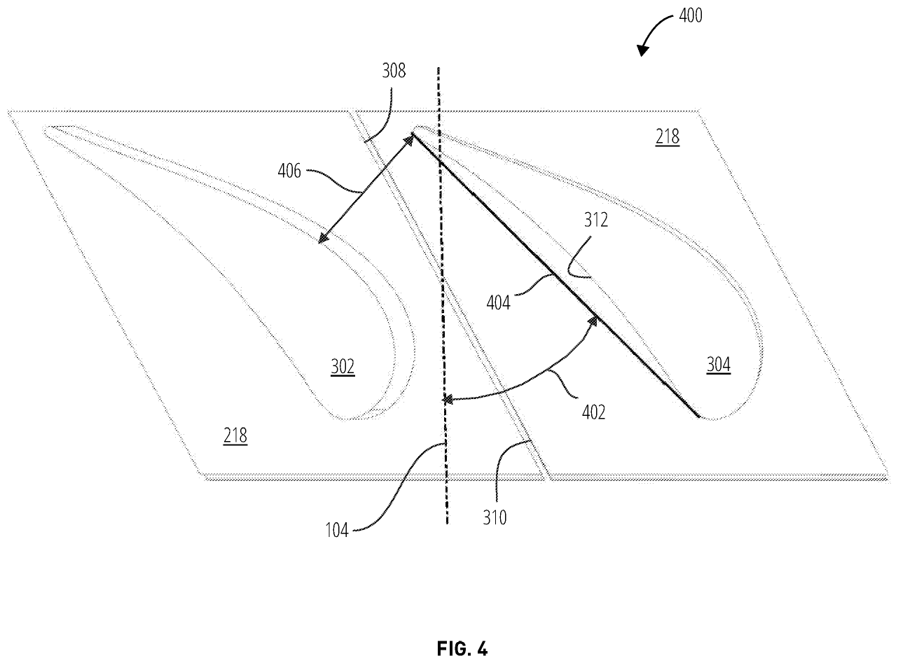

FIG. 2 better illustrates a single stage 200 including a row of stationary vanes 202 and a row of rotating blades 204. FIG. 2 is a longitudinal cross-section taken in a plane that passes through and contains the central axis 104. The row of stationary vanes 202 includes a number of stationary vanes 206 stacked in a circumferential direction and in contact with one another. Each of the stationary vanes 206 includes an inner rail 208 that defines a platform 218 and is positioned near a rotor 216 to form a seal therebetween. An outer rail 210 engages a casing 214 to hold the row of stationary vanes 202 in the desired operating position. More specifically, the outer rail 210 of each of the stationary vanes 206 includes a bolt face 222 that is received within a receiving groove 220. The receiving groove 220 is machined to a plane that is normal to the central axis 104 of the gas turbine engine 100. Each bolt face 222 is machined to a desired plane that determines a stagger angle 402 (illustrated in FIG. 4) for row of stationary vanes 202. Any adjustment of the plane in which the bolt face 222 is machined results in a corresponding change in the stagger angle 402 for the row of stationary vanes 202.

The row of stationary vanes 202 is centered around the central axis 104 (sometimes referred to as longitudinal axis or rotational axis) with each of the stationary vanes 206 extending along a radial line 212 that extends radially from the central axis 104.

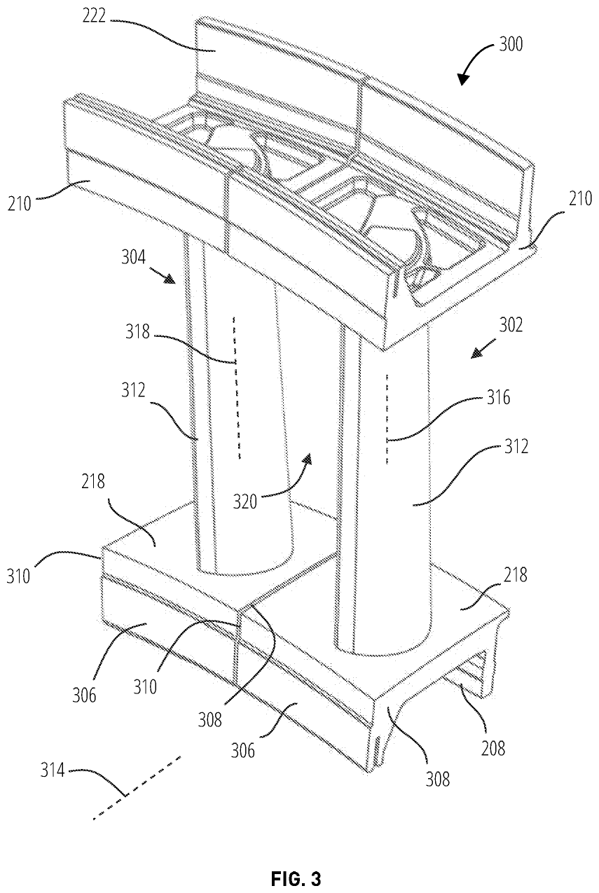

FIG. 3 illustrates a partial row of stationary vanes 300 including a first stationary vane 302 and a second stationary vane 304 positioned in or near an operating position. The second stationary vane 304 is identical to the first stationary vane 302. As used herein, the term “identical” means that the blades or vanes are manufactured to the same design which includes certain dimensional and angular tolerances. As such, identical blades can have slight dimensional or angular differences. Because the first stationary vane 302 and the second stationary vane 304 are identical, only the first stationary vane 302 will be described in detail.

The first stationary vane 302 includes an inner rail 208 that is arranged adjacent to or in contact with the rotor 216. A vane portion 312 extends from the inner rail 208 to an opposite end which may include an outer rail 210. Each vane portion 312 extends along a different radial line such that the first stationary vane 302 follows a first radial line 316 and the second stationary vane 304 follows a second radial line 318. The outer rail 210 attaches to a stationary element such as a casing 214, housing, shell, blade ring and the like.

The inner rail 208 includes an inlet face 306, a suction side face 308, a pressure side face 310, and a platform 218 from which the vane portion 312 extends. Each of the suction side face 308 and pressure side face 310 are planar surfaces arranged to abut one another during the stacking of the row of stationary vanes 202.

Each stationary vane 206 such as the first stationary vane 302 is stacked in contact with another stationary vane 206 such as the second stationary vane 304. More specifically, the pressure side face 310 of the first stationary vane 302 is in direct contact with the suction side face 308 of the second stationary vane 304 to define a flow path 320 between the associated vane portions 312.

The inlet face 306 of the first stationary vane 302 cooperates with the inlet face 306 of the second stationary vane 304 to partially define a continuous annular surface that extends around the central axis 104. As used herein, the term “continuous” means that there are no undesirable steps in the continuous annular surface. As one of ordinary skill in the art will realize, there will be small discontinuities or gaps at the interface between each suction side face 308 and pressure side face 310. However, this discontinuity will not be a step in which the inlet face 306 of either the first stationary vane 302 or the second stationary vane 304 extends out of the plane of the other inlet face 306. In other words, “continuous” means that the inlet face 306 of each of the first stationary vane 302 and the second stationary vane 304 are in the same plane (within the design tolerance) with only the interface therebetween deviating from that plane.

The platform 218 of the first stationary vane 302 cooperates with the platform 218 of the 304 to partially define a continuous curvilinear surface that defines the inner boundary of the flow path 320. The continuous curvilinear surface is circular in a cross section taken normal to the central axis 104. However, as illustrated in FIG. 2, the continuous curvilinear surface formed by the platforms 218 defines an elliptical cross-section.

FIG. 4 is a radial view of partial row of stationary vanes 400 better illustrating a stagger angle 402. The vane portion 312 inherently defines a chord 404 that extends between a tangent point of the leading edge and a tangent point of the trailing edge. The chord 404 cooperates with the interface between the suction side face 308 and the pressure side face 310 to define the stagger angle 402. Of course, lines other than the chord 404 could be used to define the orientation of the vane portion 312.

To adjust the stagger angle 402 of a particular row of stationary vanes 202, one adjusts the plane in which the bolt face 222 is machined. In addition, one may need to change the angle of the suction side face 308 and the pressure side face 310.

Changing the stagger angle 402 changes the size of the throat area 406. The throat area 406 is selected to assure that the flow area can accommodate the maximum expected flow rate for the design of the gas turbine engine 100. Thus, for a lower flow engine, one could rotate the vane portions 312 to a more closed position which results in a smaller throat area 406.

When a gas turbine engine 100 is designed, one parameter in performance is the throat area 406, which is a major influence on the pressure ratio developed by the compressor section 106 when the throat area 406 is in the compressor section 106 and effects the efficiency of the turbine section 110 when the throat area 406 is in the turbine section 110. This throat area 406 is fixed by the geometry of the stationary vanes 206, which are generally formed as castings that are expensive to change. When developing different variants of a gas turbine engine 100 with either higher or lower mass flows it can become necessary to change this throat area 406 to optimize the new gas turbine engine 100 performance.

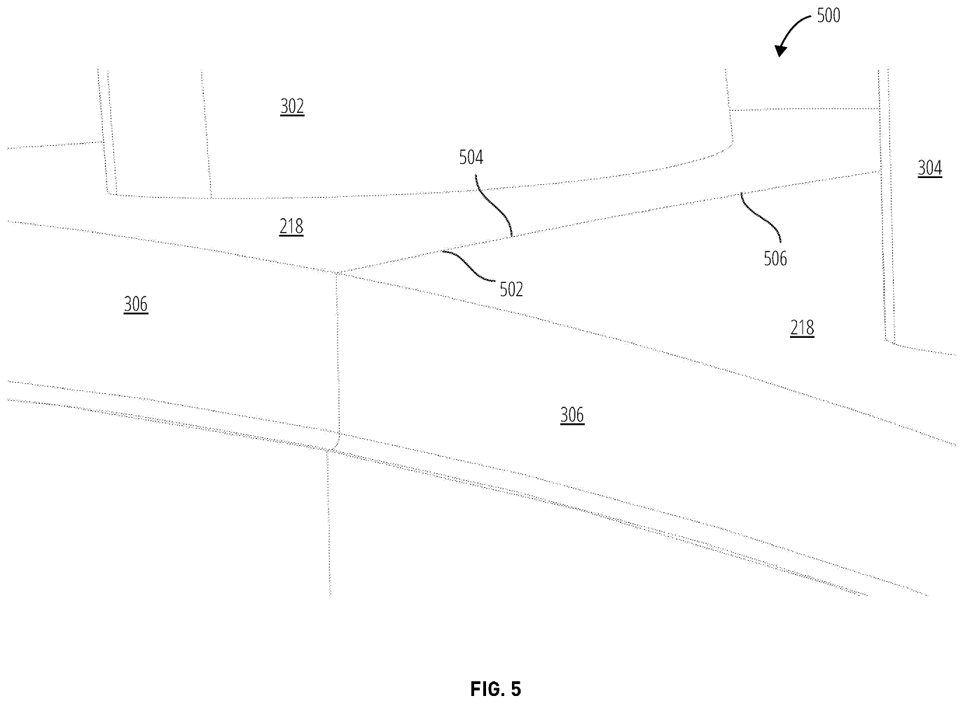

FIG. 5 illustrates the first stationary vane 302 positioned in contact with the second stationary vane 304 with the bolt face 222 machined to the design plane to achieve the on-design stagger angle 402. A first interface edge 502 is defined by the intersection of the platform 218 and the suction side face 308 of the first stationary vane 302 and a second interface edge 504 is defined by the intersection of the platform 218 and the pressure side face 310 of the second stationary vane 304. When the first stationary vane 302 and the second stationary vane 304 are arranged with the on-design stagger angle 402 the first interface edge 502 and the second interface edge 504 are adjacent one another to define a common edge 506.

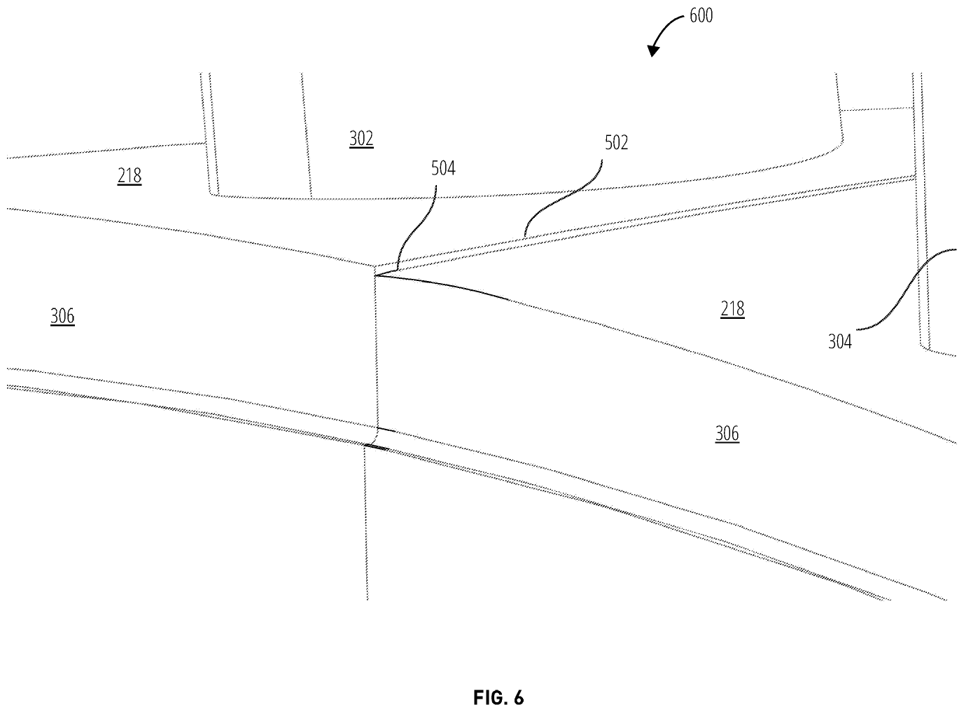

FIG. 6 illustrates the first stationary vane 302 and the second stationary vane 304 arranged at an off-design stagger angle 402, wherein the bolt face 222 of each vane is machined at a slightly different angle than the design angle.

Forming each bolt face 222 at an off-design angle can cause a step pattern to form at the inlet face 306 and at the platform 218. The steps in the flow path 320 can trip the flow, lower performance of the gas turbine engine 100 and are susceptible to damage from hot gas impingement. Each inlet face 306 can be machined or ground to eliminate the step pattern. However, the platforms 218 cannot typically be modified as the modification would change the flow area. The illustrated arrangement of the platform 218 greatly reduces the size of the step at the platform 218 such that the step is within acceptable tolerances (i.e., less than 0.25 mm). As illustrated in FIG. 6, the off-design stagger angle shifts the positions of the first interface edge 502 and the second interface edge 504 with respect to one another such that there is no common edge 506. However, the size of the step is small and remains within the design tolerance.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A gas turbine engine including a rotor rotatable about a central axis, the gas turbine engine comprising:
a turbine stage including a stationary portion and a rotating portion made up of a number of rotating blades; and
a plurality of stationary vanes arranged to define the stationary portion, each stationary vane including an inner rail having an inlet face, a suction side face, a pressure side face, and a platform, a vane portion extending along a radial line from the platform and defining one of a first stagger angle and a second stagger angle with respect to the central axis, the platform having an elliptical cross-section in a plane that includes the central axis.

2. The gas turbine engine of claim 1, wherein the difference between the first stagger angle and the second stagger angle is less than five degrees.

3. The gas turbine engine of claim 1, wherein the inlet face defines a continuous annular surface when the stationary vanes are arranged at the first stagger angle and defines a stepped annular surface when the stationary vanes are arranged at the second stagger angle.

4. The gas turbine engine of claim 1, wherein the platforms of adjacent stationary vanes cooperate to define a stepped interface that includes a step between each pair of adjacent stationary vanes and wherein each step is less than 0.25 mm.

5. The gas turbine engine of claim 1, wherein the plurality of stationary vanes define a first throat area when the stationary vanes are arranged at the first stagger angle and a second throat area when the stationary vanes are arranged at the second stagger angle, the second throat area being smaller than the first throat area.

6. The gas turbine engine of claim 5, wherein the second throat area is less than ten percent smaller than the first throat area.

7. A gas turbine engine comprising:
a first stationary vane including an inner rail having an inlet face, a suction side face, a pressure side face, and a platform, a vane portion extending along a radial line from the platform and defining one of a first stagger angle and a second stagger angle with respect to a central axis; and
a second stationary vane identical to the first stationary blade, the suction side face of the second stationary vane positioned in contact with the pressure side face of the first stationary vane to define a first throat area when the first stationary vane and the second stationary vane are oriented at the first stagger angle, and defining a second throat area when the first stationary vane and the second stationary vane are oriented at the second stagger angle, the inlet face of the first stationary vane cooperating with the inlet face of the second stationary vane to define a continuous annular surface and the platform of the first stationary vane cooperating with the platform of the second stationary vane to define a continuous curvilinear surface when the first stationary vane and the second stationary vane are oriented at the first stagger angle, and the platform of the first stationary vane cooperating with the platform of the second stationary vane to define a stepped surface when the first stationary vane and the second stationary vane are oriented at the second stagger angle.

8. The gas turbine engine of claim 7, wherein the difference between the first stagger angle and the second stagger angle is less than five degrees.

9. The gas turbine engine of claim 7, wherein the stepped surface includes a step between each pair of adjacent stationary vanes and wherein each step is less than 0.25 mm.

10. The gas turbine engine of claim 7, wherein the second throat area is smaller than the first throat area.

11. The gas turbine engine of claim 7, wherein the second throat area is less than ten percent different than the first throat area.

12. The gas turbine engine of claim 10, wherein each platform has an elliptical cross-section in a plane that includes a central axis of the gas turbine engine.

13. A method of setting the throat area of a row of stationary vanes for a gas turbine engine, the method comprising:
forming each stationary vane of the row of stationary vanes to include an inner rail having an inlet face, a suction side face, a pressure side face, and a platform, a vane portion extending along a radial line from the platform and defining a first stagger angle and an outer rail including a bolt face;
adjusting a plane of the bolt face of each of the stationary vanes to define a second stagger angle; and
positioning the suction side face of each stationary vane in contact with the pressure side face of an adjacent stationary vane, wherein the inlet face of each of the stationary vanes cooperate to define a continuous annular surface, the platform of each of the stationary vanes cooperate to define a continuous curvilinear surface, and the vane portion of each of the stationary vanes cooperate to define a first throat area when the stationary vanes are not adjusted, and wherein the platform of each of the stationary vanes cooperate to define a stepped surface, and the vane portion of each of the stationary vanes cooperate to define a second throat area when the stationary vanes are adjusted.

14. The method of claim 13, wherein each bolt face defines an original plane and wherein the adjusting step includes removing material from each bolt face such that a new bolt face is not parallel to the original plane.

15. The method of claim 13, wherein the forming step includes forming the platform to follow an elliptical cross-section in a plane that includes a central axis of the gas turbine engine.

16. The method of claim 13, wherein the difference between the first stagger angle and the second stagger angle is less than five degrees.

17. The method of claim 13, wherein the stepped surface includes a step between each pair of adjacent stationary vanes and wherein each step is less than 0.25 mm.

18. The method of claim 13, wherein the second throat area is smaller than the first throat area.

19. The method of claim 13, wherein the second throat area is less than ten percent different than the first throat area.
